(19) United States
(12) Patent Application Publication
(10) Pub. No.: US 2019/0359054 A1
(43) Pub. Date: Nov. 28, 2019

(54) POWER TAKE-OFF AND PARTS THEREOF

(71) Applicant: Scania CV AB, Södertälje (SE)

(72) Inventors: Daniel PETERSEN, Södertälje (SE); Lars BERGKVIST, Täby (SE)

(73) Assignee: Scania CV AB, Södertälje (SE)

(21) Appl. No.: 16/469,936

(22) PCT Filed: Dec. 13, 2017
(86) PCT No.: PCT/SE2017/051261

§ 371 Date: Jun. 14, 2019

(30) Foreign Application Priority Data
Dec. 22, 2016 (SE) 1651716-1

(51) Int. Cl. B60K 25/06; B60K 17/28; F16H 57/04; F16H 1/22; F16H 57/00

(52) U.S. Cl. CPC B60K 25/06; B60K 17/28; F16H 57/0006; F16H 1/22; F16H 57/0436

(57) ABSTRACT

The present disclosure relates to a main power take-off (PTO) transmission unit of the sandwich type for a vehicle and to a PTO output unit. The main PTO transmission unit comprises a first gearing and a first housing, in which the first gearing is arranged. The first housing is arranged to be attachable to a second housing of the PTO output unit. The PTO output unit comprises a second gearing arranged in the second housing. The second housing is arranged to be attachable to the first housing of a main PTO transmission unit. The present disclosure further relates to a PTO comprising the main PTO transmission unit and the PTO output unit as well as to a powertrain and a vehicle.

### CROSS-REFERENCE TO RELATED APPLICATIONS

This application is a national stage application (filed under 35 § U.S.C. 371) of PCT/SE2017/051261, filed Dec. 13, 2017 of the same title, which, in turn, claims priority to Swedish Application No. 1651716-1 filed Dec. 22, 2016; the contents of each of which are hereby incorporated by reference.

### FIELD OF THE INVENTION

The present disclosure relates to a main power take-off, PTO, transmission unit, to a PTO output unit, a PTO, a powertrain and a vehicle. In particular, the present disclosure relates to such a PTO of a sandwich type.

### BACKGROUND OF THE INVENTION

So-called power take-offs, PTOs, are used in vehicles for providing power to other functions of the vehicle than the propulsion of the vehicle. A PTO is usually placed in connection to the power flow between an engine of the vehicle and at least one of the driving wheels. The PTO then usually has an extra output shaft. This extra output shaft can rotate when the engine of the vehicle provides an output torque. It is then possible to connect extra equipment such as, for example, a hydraulic pump, a winch, a water pump, a compactor, or the like, to the extra output shaft of the PTO. This extra equipment can then receive power and/or rotational movement from the engine of the vehicle.

The present disclosure in particular relates to PTOs of the sandwich type. Such PTOs are mounted in the power transmission path between the engine and the transmission (which may include a clutch and a gearbox). Hence, the PTO is connected in series with the engine and the transmission. The PTO may thus be directly connected to the engine output shaft. Due to the sandwich mounting style of the PTO, the gearbox (and clutch) will be spaced from the engine by the PTO.

Since the extra equipment, which can be connected to the sandwich type PTO, might have quite different demands regarding rotational speed, provided torque, space requirements, and so on, it is usually not possible to provide one PTO fit for all purposes. Instead, several PTOs have to be designed to fulfil the special requirements of different extra equipment, which is demanding due to the constrained space between the engine and the transmission. An operator of a vehicle has to decide about the purpose of the PTO and usually a manufacturer of the vehicle will then build in the corresponding PTO between the engine and the transmission in the vehicle. This is comparable to choosing a usable gearbox or a usable engine for a vehicle, which will then be built in by the manufacturer. Since different PTOs have to be provided for different purposes, this increases costs compared to the case where one PTO would fit all purposes. The increased cost is, among others, due to the need of developing, producing, storing, and planning for several different PTOs.

It would thus be an advantage to get rid of at least some of the disadvantages associated with the need of different PTOs.

Some known examples of PTOs are described in the documents US2010242638 A1 and WO2015005884 A1. In the first named document, an auxiliary clutch is used behind the main gearbox clutch for connecting the PTO. In the second document, a solution with a desired number of PTOs is presented.

### SUMMARY OF THE INVENTION

It is an objective of the present disclosure to get rid of at least some of the disadvantages associated with the need of different PTOs. It is a further objective of the present disclosure to limit the amount of different components needed in relation to different PTOs. It is a further objective of the present disclosure to provide a more flexible solution for providing a PTO. It is a further objective of the present disclosure to provide an alternative to existing PTOs.

According to a first aspect, a main power take-off (PTO) transmission unit for a vehicle is provided. The main PTO transmission unit is of the sandwich type. The main PTO transmission unit comprises a first gearing and a first housing. The first gearing is arranged in the first housing. The first housing is arranged to be attachable to a second housing of a PTO output unit. Further, the first gearing is arranged to transfer torque to a second gearing of the PTO output unit when the first housing is attached to the second housing. The second gearing is arranged in the second housing.

According to a second aspect, a PTO output unit for a vehicle is provided. The PTO output unit comprises a second gearing and a second housing. The second gearing is arranged in the second housing. The second housing is arranged to be attachable to the first housing of the main PTO transmission unit according to the first aspect. Further, the second gearing is arranged to be engaged with the first gearing of the main PTO unit when the first housing is attached to the second housing.

The present aspects allow providing one and the same main PTO transmission unit for several purposes. By providing the PTO in the form of two separate units, wherein one unit is attachable to the other, the PTO output unit can be adapted to the intended use of the PTO and being exchanged if needed. Hence, only the PTO output unit needs to be changed in case the intended use of the PTO changes. As the one and the same main PTO transmission unit can be used for several purposes, development costs and storage costs can be lowered. Further, the same component for several purposes is inserted into the powertrain (driveline) of the vehicle, which in particular is advantageous for sandwich type PTOs, which generally have to be designed under strict space constraints. Thus, a later exchange of the PTO output unit does not require any adaptions in the powertrain between the engine and the driving wheels.

In the present specification, the term sandwich type PTO may include a PTO adapted to be mounted between a power source (such as an engine) and a transmission (such as including a gearbox) of the vehicle. Hence, the main PTO transmission unit of the sandwich type may be adapted to be mounted in series with, and in between, the power source and the transmission of the vehicle.

In one embodiment, the main PTO transmission unit according to the first aspect further comprises an input shaft arranged to be connected to an output shaft of a power source of the vehicle, whereby power is enabled to be transferred from the power source to the main PTO transmission unit. As the main PTO transmission unit is of the sandwich type, the input shaft may be adapted to be connected in series with the output shaft of the power source.

In one embodiment, the first gearing comprises one or more gears (gear wheels) arranged to transfer torque from the input shaft to the second gearing when the first housing is attached to the second housing.

In one embodiment, the main PTO transmission unit further comprises a first coupling arrangement. The first coupling arrangement is arranged to couple and decouple the first gearing to the input shaft. Thereby, the first gearing does not need to rotate in case no output power and/or torque is needed for an extra equipment. Thus, drag losses are reduced.

In one embodiment, at least one gear of the first gearing has an opening. The input shaft extends through the opening. This allows for a convenient way for coupling and decoupling the first gearing from the input shaft.

In one embodiment, the main PTO transmission unit further comprises a brake arrangement. The brake arrangement is arranged to brake at least one gear of the first gearing of the main PTO transmission unit in case the first coupling arrangement is in a state, in which the first gearing is decoupled from the input shaft. This allows to prevent the gearing in the main PTO transmission unit from rotating. This is especially practical in case the gearing has low inertia as it otherwise might rotate unintentionally.

In one embodiment, the brake arrangement is arranged not to brake the at least one gear in case the first coupling arrangement is in a state, in which the first gearing is coupled to the input shaft. This assures that the first gearing can rotate when needed.

In one embodiment, the main PTO transmission unit further comprises a first output shaft, and a second coupling arrangement. The second coupling arrangement is arranged to couple and decouple the first output shaft to the input shaft. This allows providing power and/or torque to an extra equipment without the need of providing propulsion to the vehicle.

In one embodiment, the second coupling arrangement comprises a torsion damper. The torsion damper is arranged on a side of a gear of the first gearing facing towards an opening in the first housing. The opening is intended for the input shaft. This allows for a more compact construction, especially when the second coupling arrangement is integrated in the main PTO transmission unit.

In one embodiment, the first output shaft is adapted to be connected to an input shaft of a gearbox of the vehicle (e.g. via a clutch).

In one embodiment, the main PTO transmission unit further comprises an oil pump. The oil pump is arranged to lubricate and cool at least some of the components of the main PTO transmission unit. This increases flexibility since the main PTO transmission unit does not need to be adapted to the oil systems of the vehicle.

In one embodiment, the main PTO transmission unit further comprises a flywheel. The flywheel is coupled to the input shaft. This allows for a compact construction since the flywheel is integrated with the main PTO transmission unit.

In one embodiment, the PTO output unit according to the second aspect further comprises a second output shaft arranged to be connected to an extra equipment of the vehicle. The second housing may comprise an opening for the second output shaft.

At least some of the objectives are also achieved by a PTO. The PTO comprises a main PTO transmission unit according to the first aspect and the PTO output unit according to the second aspect.

In one embodiment, the first and the second housing are attached to each other by fastening means.

At least some of the objectives are also achieved by a powertrain for a vehicle. The powertrain comprises the PTO as defined above.

At least some of the objectives are also achieved by a vehicle comprising the powertrain as defined above.

The vehicle, powertrain and the PTO have corresponding advantages as have been described in relation to the main PTO transmission unit and the PTO output unit.

Further advantages of embodiments the present invention are described in the following detailed description and/or will arise to a person skilled in the art when performing the invention.

### BRIEF DESCRIPTION OF THE DRAWINGS

For a more detailed understanding of embodiments of the present invention and its objects and advantages, reference is made to the following detailed description, which should be read together with the accompanying drawings. Same reference numbers refer to same components in the different figures. In the following,

FIG. 1 shows, in a schematic way, a vehicle according to one embodiment of the present invention;

FIG. 2 shows, in a schematic way, a PTO according to an embodiment of the present invention;

FIG. 3 shows, in a schematic way, a cross-section of a side view of an embodiment of a PTO according to the present invention;

FIG. 4 shows, in a schematic way, a side view of an embodiment of a PTO according to the present invention;

FIG. 5 shows, in a schematic way, a rear view of an embodiment of a PTO according to the present invention; and

FIG. 6 shows, in a schematic way, a front view of an embodiment of a PTO according to the present invention.

### DETAILED DESCRIPTION

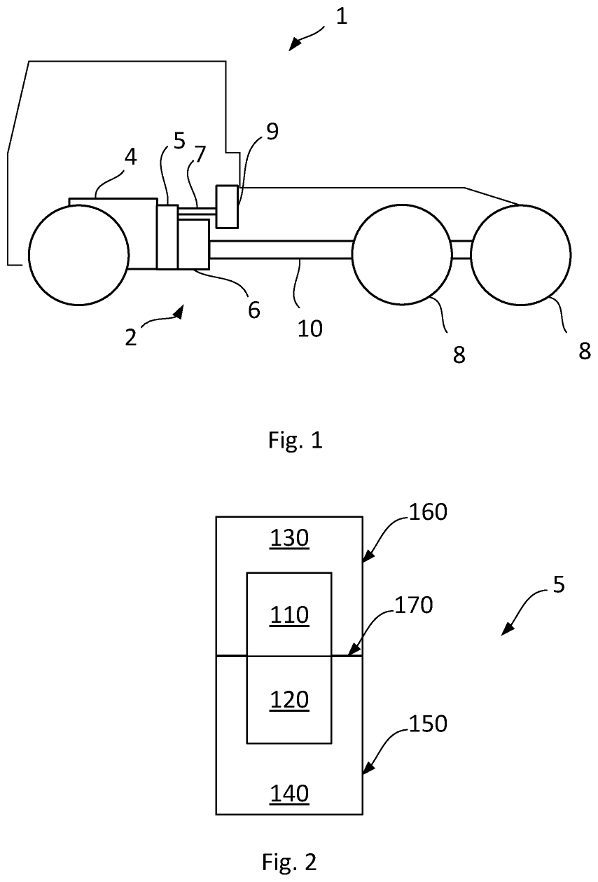

FIG. 1 shows schematically a side view of a vehicle 1. The vehicle can be a truck. However, any other vehicle, such as a passenger car, a tractor, a boat, a ship, or the like, is possible as well. The vehicle comprises a powertrain 2. The powertrain 2 can be provided with a gearbox 6. The powertrain 2 comprises also a power source, such as an engine 4, such as an internal combustion engine or an electric machine. The gearbox 6 is connected to driving wheels 8 of the vehicle 1 via a propeller shaft 10. A power take-off 5, PTO 5, is placed between the engine 4 and the gearbox 6. This type pf PTO is called a sandwich type PTO, which means that the PTO 5 is adapted to be positioned in series (as seen in the main power flow of the powertrain) with the power source 4 and the gearbox 6.The PTO 5 may be connected to an extra output shaft 7. The extra output shaft 7 may in turn be connected to an extra equipment 9. By that, the power and/or torque from the engine 4 can be used by the extra equipment 9.

FIG. 2 shows, in a schematic way, a PTO 5 according to an embodiment of the present invention. The PTO 5 is of the sandwich type as indicated in FIG. 1. The PTO comprises a main PTO transmission unit 140 and a PTO output unit 130. The main PTO transmission unit 140 comprises a first housing 150 and a first gearing 120. The first gearing 120 of the main PTO transmission unit 140 can comprise one or several gears. The PTO output unit 130 comprises a second housing 160 and a second gearing 110. The second gearing 110 of the PTO output unit 130 can comprise one or several gears. The first gearing 120 is arranged in the first housing 150. The second gearing 110 is arranged in the second housing 160.

The first housing 150 and the second housing 160 are attachable to each other. The attachment can be provided via an interface 170. The interface 170 can be a standardised interface. Having the first and second housing attachable to each other has the advantage that the PTO output unit can be exchanged without the need to change anything in the power transmission from the engine to the drive wheels. Thus, it is possible to provide a different PTO if needed by only changing the PTO output unit 130. A common main PTO transmission unit 140 can be used for all purposes. Thus, only one main PTO transmission unit 140 needs to be provided for a manufacturer of the vehicles instead of several PTO units as in the prior art.

Thus, the solution to divide the PTO into a main PTO transmission unit 140 and a PTO output unit 130, wherein the main PTO transmission unit 140 preferably is kept the same for different purposes, makes constructions of vehicles less complex, but still allows increased flexibility for providing different extra equipment for the vehicle. Further, a later exchange of extra equipment, which requires a different setup in the PTO will be facilitated since only a part of the PTO, namely the PTO output unit 130, needs to be changed. This lowers the cost of changing the setup of the PTO since a disconnecting and reconnecting of the PTO to the engine and the gearbox, respectively, will not be needed to be performed.

For example, the first housing 150 may comprise an opening arranged to mate with an opening of the second housing 160. These openings may enable the first and second gearings 120, 110 to mesh (engage) with each other.

The first gearing 110 and the second gearing 120 are preferably in rotational connection with each other. The interface between the first and the second housings 150, 160, is preferably adapted such that an exchange is facilitated. In one example, the attachment between the first and the second housings 150, 160 may be realized by fastening means, such as screws.

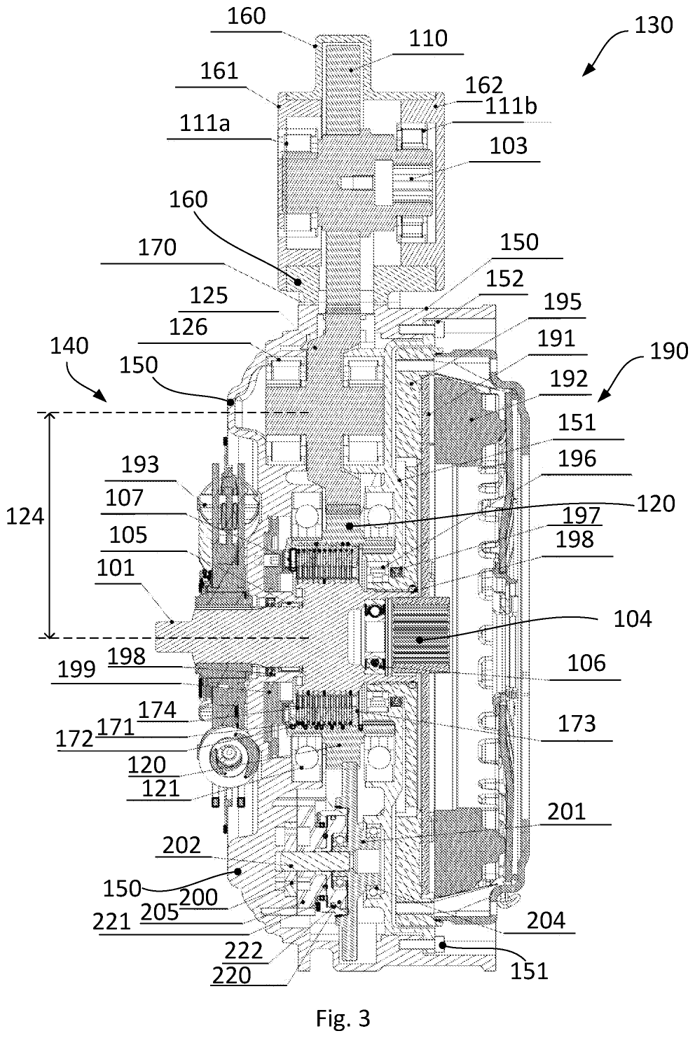

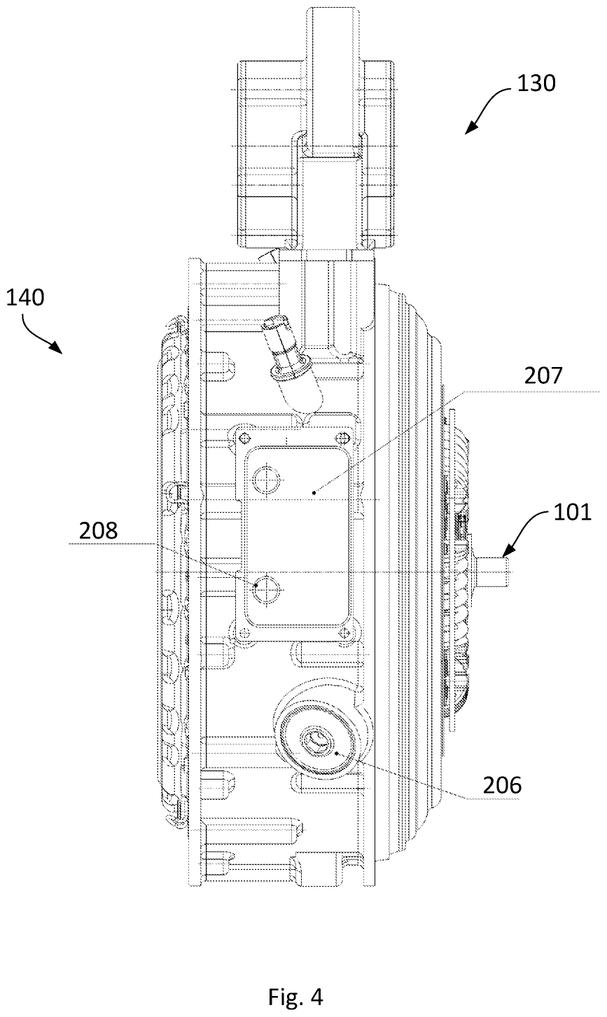

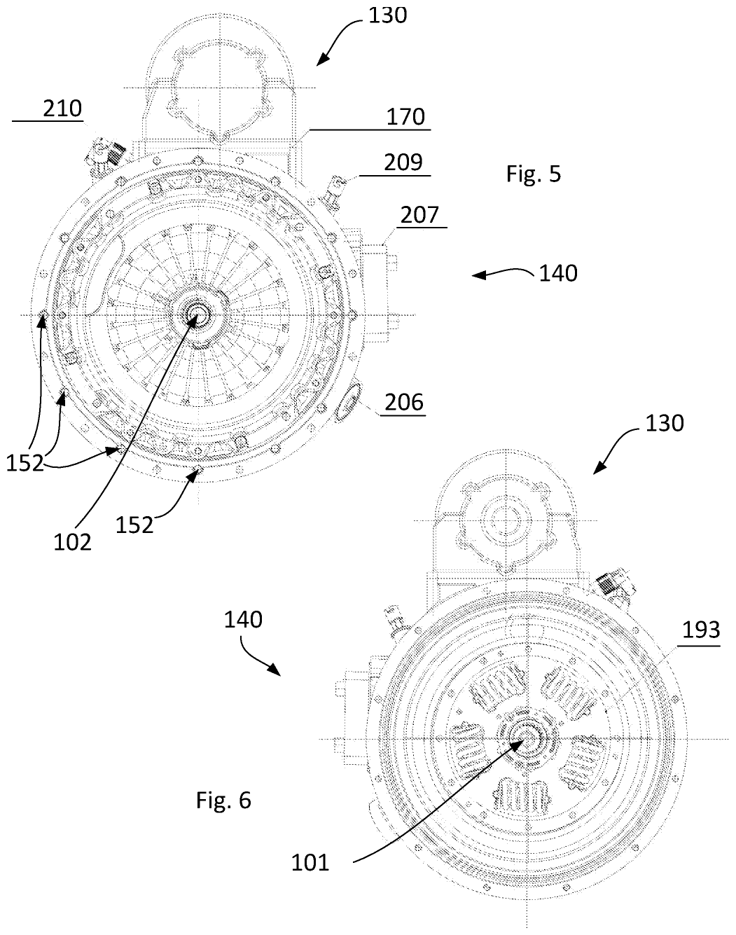

In FIG. 3-6 a specific embodiment the present disclosure is described. Several examples and further developments of the present disclosure are described in relation to this embodiment. It should be understood that these examples and developments can be performed independently of the specific embodiment described here. The FIGS. 3-6 show the same embodiment of the present disclosure. FIG. 3 shows a cross-section of a side view of the PTO, FIG. 4 a side view from the side, which is opposite the side of FIG. 3, FIG. 5 shows a rear view, and FIG. 6 a front view of the PTO. The term rear view relates to the fact that this side of the PTO is to be connected to the gearbox. The term front view relates to the fact that this side of the PTO is to be connected to the engine.

The PTO comprises a PTO output unit 130 and a main PTO transmission unit 140. An interface 170 is provided between the PTO output unit 130 and the main PTO transmission unit 140. The main PTO transmission unit 140 comprises an input shaft 101. The input shaft 101 is adapted to be connected to an output shaft of an engine. The main PTO transmission unit 140 can further comprise a first output shaft 102 (illustrated in FIG. 5). The first output shaft 102 is adapted to be connected to an input shaft of a gearbox. The PTO output unit 130 comprises a second output shaft 103. The second output shaft 103 is arranged to be connected to an extra equipment of the vehicle to be driven by the PTO.

The PTO output unit 130 comprises a second housing 160. The second housing 160 is adapted to provide an opening for the second output shaft 103. In the shown example, a first cover 161 is provided at the PTO output unit 130. This first cover 161 is arranged to cover one side of the second housing 160. In the shown example, a second cover 162 is provided at the PTO output unit 130. The second cover 162 is arranged to cover another side of the second housing 160.

In the shown example, the PTO output unit 130 comprises a second gearing, which in the present example is constituted by a second gear 110. The second gear 110 circumferentially surrounds the second output shaft 103. The second gear 110 is arranged in the second housing 160. In one example the second gear 110 and/or the second output shaft 103 is mounted on second bearings 111a, 111b in the second housing 160. The second bearings 111a, 111b can be cylindrical roller bearings. In the shown example, the second bearings comprise a first bearing arrangement 111a on one side of the second gear 110 and a second bearing arrangement 111b on the other side of the second gear 110.

The main PTO transmission unit 140 comprises a first gearing, which in the present example is comprises a first gear 120. The first gear 120 has an opening. The input shaft 101 is arranged through the opening of the first gear 120. The first gear 120 thus circumferentially surrounds the first input shaft 101. The first gearing of the main PTO transmission unit 140 can comprise further gears. As an example, the main PTO transmission unit 140 can comprise a third gear 125. In one example, the main PTO transmission comprises a first gear 120 and a third gear 125. The central axis of the third gear 125 can be arranged at a first distance 124 from the central axis of the first gear. The first gear 120 and the third gear 125 are in rotational connection with each other. In one example, the first gear 120 and the third gear 125 are in mesh with each other.

When assembled, the second gear 110 of the PTO output unit 130 and the third gear 125 of the main PTO transmission unit 140 are in rotational connection with each other. In one example, the second gear 110 and the third gear 125 are in mesh with each other. As a result, the first gear 120 and the second gear 110 are in rotational connection to each other. Providing a third gear has the advantage that the offset between the input shaft 101 and the second output shaft 103 can be increased without needing too big gears. In one example, further gears can be arranged between the first and the second gear.

The main PTO transmission unit 140 comprises a first housing 150. The first housing 150 has an opening for the input shaft 101. In the shown example, a third cover 151 is provided at the main PTO transmission unit 140. This third cover 151 is arranged to cover one side of the first housing 150. In the shown example, the third cover 151 is attached to the first housing 150 by a at least one screw 152. Not all of these screws are denoted by reference signs on FIG. 5 for not overloading the figure.

The main PTO transmission unit 140 comprises a first coupling arrangement. The first coupling arrangement is arranged to couple and decouple the first gear 120 to the input shaft 101. The first coupling arrangement can comprise a dog clutch. The first coupling arrangement can comprise a multi-plate clutch. The first coupling arrangement can be air-actuated. In the shown example, the first coupling arrangement comprises clutch discs 174. The first coupling arrangement further comprises steel discs 171, separation springs 172, and/or a pressure plate 173. Preferably, the first coupling arrangement is operated so that the first gear 120 is decoupled from the input shaft 101 in case the extra equipment does not require power and/or torque from the engine. Preferably, the first coupling arrangement is operated so that the first gear 120 is coupled to the input shaft 101 in case the extra equipment does require power and/or torque from the engine.

The main PTO transmission unit 140 comprises a second coupling arrangement. The second coupling arrangement is arranged to couple and decouple the first output shaft 102 to the input shaft 101. The first output shaft 102 is not shown in FIG. 3 but in FIG. 5. However, the first output shaft is intended to be placed in the horizontal extension of the input shaft 101. The first output shaft 102 then preferably meshes with the gear arrangement 104. The second coupling arrangement preferably comprises a clutch 190, which may be main clutch of the powertrain arranged to control the transfer of torque between the engine and the gearbox. In the shown example, the clutch comprises a clutch disc 191 and a clutch cover 192. The second coupling arrangement can further comprise at least one torsion damper 193.

This allows operating the PTO in either one of the following modes. In a first mode, power from the engine is transmitted via the PTO to the gearbox. The first coupling arrangement is in a state, in which the second output shaft 103 of the PTO output unit 130 is decoupled and the second coupling arrangement is in a state where the first output shaft 102 is connected to the input shaft 101 of the main PTO transmission unit 140. Thus, all output power and torque is available at the gearbox and no torque is transferred to the second output shaft 103. The first mode may e.g. be used when the vehicle is driving and no extra equipment is in use.

In a second mode, power from the engine is transmitted via the PTO to the gearbox and to the second output shaft 103. The first coupling arrangement is in a state, in which the second output shaft 103 is coupled to the input shaft 101 and the second coupling arrangement is in a state, in which the first output shaft 102 is connected to the input shaft 101. Thus, output power and/or torque is available at both the gearbox and the second output shaft 103 of the PTO output unit 130. The second mode may e.g. be used when the vehicle is driving while extra equipment is in use.

In a third mode, power from the engine is transmitted via the PTO to the second output shaft 103 of the PTO output unit 130. The first coupling arrangement is in a state, in which the second output shaft 103 is coupled to the input shaft 101 and the second coupling arrangement is in a state, in which the first output shaft 102 is disconnected from the input shaft 101. Thus, all output power and/or torque is available at the second output shaft 103 of the PTO output unit 130 and no torque is transferred to the gearbox. The third mode may e.g. be used when the vehicle is stationary and extra equipment is in use.

In a fourth mode, power from the engine is not transmitted to any output shaft. The first coupling arrangement is in a state, in which the second output shaft 103 of the PTO output unit 130 is decoupled from the input shaft 101 of the main PTO transmission unit 140 and the second coupling arrangement is in a state, in which the first output shaft 102 is decoupled from the input shaft 101. The fourth mode may e.g. be used when the vehicle is stationary and no extra equipment is in use.

In a preferred example, the at least one torsion damper 193 is arranged at another (opposite) side of the first gear 120 than the clutch 190. In the shown example, the torsion damper 193 is arranged on the side of the first gear 120, which is oriented towards the engine.

In the shown example, the clutch 190 is arranged on the side of the first gear 120, which is oriented towards the gearbox.

In one example, the third gear 125 is mounted on third bearings 126 in the first housing 150. The third bearings 126 can be cylindrical roller bearings. In the shown example the third bearings 126 comprise a first bearing arrangement on one side of the third gear 125 and a second bearing arrangement on the other side of the third gear 125.

In one example, the first gear 120 is mounted on first bearings 121 in the first housing 150. The first bearings 121 can be ball bearings. In the shown example, the first bearings 121 comprise a first bearing arrangement on one side of the first gear 120 and a second bearing arrangement on the other side of the first gear 120.

In one example, the input shaft 101 is mounted on first shaft bearings 105 in the first housing 150. The first shaft bearings 105 can be roller bearings, such as drawn cup needle roller bearings.

In one example, the first output shaft 102 is mounted on second shaft bearings 106 in the first housing 150. The second shaft bearings 106 can be ball bearings.

In one example, the first coupling arrangement is mounted to the first housing 150 via a first coupling bearing arrangement 107. The first coupling bearing arrangement 107 can comprise roller bearings, such as axial needle roller bearings.

The main PTO transmission unit 140 can comprise a flywheel 195. The flywheel 195 can be connected to the input shaft 101. This connection can be performed via a spline, screw(s), nut(s), and/or via welding. The flywheel can be arranged to store rotational energy from the engine. The flywheel 195 can be mounted to the first housing 150 on flywheel bearings 196. The flywheel bearings 196 can be roller bearings, preferably cylindrical roller bearings.

A first sealing 197 can be provided for sealing a gap between the flywheel 195 and the first housing 150. An O-ring 198 can be provided for sealing a gap between the flywheel 195 and the input shaft 101. A second sealing 198 can be provided for sealing a gap between the input shaft 101 and the first housing 150.

The main PTO transmission unit 140 can comprise a piston 199. The piston 199 can be arranged for actuating a clutch in the first coupling arrangement.

The main PTO transmission unit 140 can further comprise an oil pump 200. The oil pump 200 can be arranged to lubricate at least some of the components of the main PTO transmission unit 140. The oil pump 200 can be arranged to cool at least some of the components of the main PTO transmission unit 140.

In one example, the PTO 140 comprises an oil pump gear 201. The oil pump gear is preferably in rotational connection with the first gear 120. The PTO can further comprise an oil pump shaft 202.

The oil pump gear 201 circumferentially surrounds the oil pump shaft 202. The oil pump gear 201 and the oil pump shaft 202 are preferably arranged in the first housing 150. The oil pump gear 201 and the oil pump shaft 202 are preferably arranged to provide power and/or torque to the oil pump 202.

In one example, the oil pump shaft 202 is mounted on oil pump shaft bearings 204 in the first housing 150. The oil pump shaft bearings 204 can be ball bearings. In the shown example the oil pump shaft bearings 204 comprise a first bearing arrangement on one side of the oil pump gear 201 and a second bearing arrangement on the other side of the oil pump gear 201.

The PTO can further comprise an oil pump cover 205. The oil pump cover can be arranged to protect the oil pump against the oil pump gear 201. The PTO can further be equipped with an oil filter 206. The oil filter 206 can be arranged for cleaning of the oil, which is used in the PTO. In one example, the PTO comprises an oil cooler 207 for cooling the oil, which is supplied by the oil pump 200. The oil cooler 200 can comprise cooling channels being arranged to cool the oil. The cooling channels can be arranged to allow for water transport. The oil cooler can have connections 208 for a water supply. The oil cooler can be arranged to be connected to the cooling system of the vehicle. The PTO can further comprise a dipstick holder 209 for an oil dipstick. The PTO can also comprise a rotational sensor 210 for surveying the rotational speed of any of the gears inside the PTO.

The main PTO transmission unit 140 can further comprise a brake arrangement. The brake arrangement is arranged to brake at least one gear of the main PTO transmission unit 140 in case the first coupling arrangement is in a state where the first gear 120 is decoupled from the input shaft 101. This allows preventing the first gear 120 from rotational movements when it is decoupled from the input shaft. The brake arrangement is arranged not to brake the first gear 120 in case the first coupling arrangement is in a state where the first gear 120 is coupled to the input shaft 101. This assures not to brake the first gear when it should rotate.

The brake arrangement can comprise a cone brake 220. In the shown example the cone brake 220 acts on the oil pump gear 201. Since the oil pump gear 201 is in rotational connection with the first gear 120, or even can be in mesh with the first gear 120 as in the shown example, a braking of the oil pump gear 201 will also brake the first gear 120. The cone brake 220 can be activated by a spring 221, such as a wave spring. The brake arrangement can further comprise X-rings 222 to seal a brake piston to ensure proper dis-engagement of a brake in the brake arrangement when the PTO is in use.

### Itemized List Of Embodiments

1. A main power take-off (PTO) transmission unit (140) of the sandwich type, comprising a first gear (120) and a first housing (150), wherein said first gear (120) is arranged in said first housing (150), characterised in that said first housing (150) is arranged to be attachable to a second housing (160) of a PTO output unit (130).

2. The main PTO transmission unit (140) according to the previous item 1, further comprising an input shaft (101) and a first coupling arrangement, wherein said first coupling arrangement is arranged to couple and decouple said first gear (120) to the input shaft (101).

3. The main PTO transmission unit (140) according to the previous item 2, wherein said first gear (120) has an opening, and wherein said input shaft (101) is arranged through the opening of said first gear (120).

4. The main PTO transmission unit (140) according to anyone of items 2-3, further comprising a brake arrangement being arranged to brake at least one gear (120, 201, 125) of the main PTO transmission unit (140) in case said first coupling arrangement is in a state where said first gear (120) is decoupled from the input shaft (101).

5. The main PTO transmission unit (140) according to the previous item 4, wherein said brake arrangement is arranged not to brake said at least one gear (120, 201, 125) in case said first coupling arrangement is in a state where said first gear (120) is coupled to the input shaft (101).

6. The main PTO transmission unit (140) according to anyone of the previous items, further comprising an input shaft (101), a first output shaft (102), and a second coupling arrangement, wherein said second coupling arrangement is arranged to couple and decouple said first output shaft (102) to the input shaft (101).

The main PTO transmission unit (140) according to the previous item 7, wherein said second coupling arrangement comprises a torsion damper (193), and wherein said torsion damper (193) is arranged on a side of said first gear (120) facing towards an opening in said first housing, which opening is intended for said input shaft (101).

7. The main PTO transmission unit (140) according to anyone of items 2-7, wherein said input shaft (101) is adapted to be connected to an output shaft of an engine (4).

8. The main PTO transmission unit (140) according to anyone of items 2-8, wherein said first output shaft (102) is adapted to be connected to an input shaft of a gearbox (6).

9. The main PTO transmission unit (140) according to anyone of the previous items, further comprising an oil pump (200) being arranged to lubricate and cool at least some of the components of the main PTO transmission unit (140).

10. The main PTO transmission unit (140) according to anyone of the previous items, further comprising a flywheel (195) being coupled to said input shaft (101).

11. A PTO output unit (130), comprising a second gear (110) and a second housing (160), wherein said second gear (110) is arranged in said second housing (160), characterised in that said second housing (160) is arranged to be attachable to a first housing (150) of a main PTO transmission unit (140).

12. The PTO output unit (130) according to the previous item 12, further comprising a second output shaft (103), and wherein said second housing (160) is adapted to provide an opening for said second output shaft (103).

13. A PTO (5), comprising said main PTO transmission unit (140) according to anyone of items 1-11 and said PTO output unit (130) according to anyone of items 12-13.

14. The PTO (5) according to the previous item 14, wherein said first and said second housing (150, 160) are attached together by fastening means.

15. A vehicle (1) comprising the PTO according to anyone of items 14-15.

1. A main power take-off (PTO) transmission unit of a sandwich type PTO unit for a vehicle, the main PTO transmission unit comprising:
a first housing arranged to be attachable to a second housing of a PTO output unit;
a first gearing arranged in the first housing,
wherein the first gearing is arranged to transfer torque to a second gearing
of the PTO output unit when the first housing is attached to the second housing of the PTO output unit, the second gearing being arranged in the second housing,
wherein the main PTO transmission unit is adapted to be mounted in series with, and in between, a power source and a transmission of the vehicle,
wherein the main PTO transmission unit further comprises an input shaft arranged to be connected to an output shaft of the power source of the vehicle; and
a first coupling arrangement, wherein the first coupling arrangement is arranged to couple and decouple the first gearing to the input shaft.

2. The main PTO transmission unit according to claim 1, wherein the first gearing comprises one or more gears arranged to transfer torque from the input shaft to the second gearing when the first housing is attached to the second housing.

3. The main PTO transmission unit according to claim 2, further comprising a brake arrangement being arranged to brake at least one gear of the first gearing of the main PTO transmission unit in case the first coupling arrangement is in a state, in which the first gearing is decoupled from the input shaft.

4. The main PTO transmission unit according to claim 2, wherein the brake arrangement is arranged not to brake the at least one gear in case the first coupling arrangement is in a state, in which the first gearing is coupled to the input shaft.

5. The main PTO transmission unit according to claim 1, further comprising a first output shaft and a second coupling arrangement, wherein the second coupling arrangement is arranged to couple and decouple the first output shaft to the input shaft.

6. The main PTO transmission unit according to claim 5, wherein the first output shaft is adapted to be connected to an input shaft of a gearbox of the vehicle.

7. The main PTO transmission unit according to claim 1, further comprising an oil pump being arranged to lubricate and cool at least some of the components of the main PTO transmission unit.

8. The main PTO transmission unit according to claim 1, further comprising a flywheel being coupled to the input shaft.

9. A main power take-off (PTO) output unit for a vehicle, the PTO output unit comprising:
a second housing and
a second gearing arranged in the second housing,
wherein the second housing is arranged to be attachable to a first housing of a main PTO transmission unit wherein said first housing comprises a first gearing,
wherein the second gearing is arranged to be engaged with the first gearing of the main PTO unit when the first housing is attached to the second housing,
wherein the first gearing is arranged to transfer torque to a second gearing of the PTO output unit,
wherein the main PTO transmission unit is adapted to be mounted in series with, and in between, a power source and a transmission of the vehicle,
wherein the main PTO transmission unit further comprises an input shaft arranged to be connected to an output shaft of the power source of the vehicle; and
a first coupling arrangement, wherein the first coupling arrangement is arranged to couple and decouple the first gearing to the input shaft.

10. The PTO output unit according to claim 9, further comprising a second output shaft arranged to be connected to an extra equipment of the vehicle.

11. A main power take-off (PTO) comprising:
a main PTO transmission unit adapted to be mounted in series with, and in between, a power source and a transmission of the vehicle, said main PTO transmission unit comprising:
a first housing; and
a first gearing arranged in the first housing;
a main PTO output unit comprising:
a second housing; and
a second gearing arranged in the second housing, wherein the second housing is arranged to be attachable to the first housing of the main PTO transmission unit, wherein the second gearing is arranged to be engaged with the first gearing of the main PTO unit when the first housing is attached to the second housing, and wherein the first gearing is arranged to transfer torque to the second gearing of the PTO output unit;
an input shaft arranged to be connected to an output shaft of the power source of the vehicle; and
a first coupling arrangement, wherein the first coupling arrangement is arranged to couple and decouple the first gearing to the input shaft.

12. A powertrain for a vehicle, the powertrain comprising a main power take-off (PTO) comprising:
a main PTO transmission unit adapted to be mounted in series with, and in between, a power source and a transmission of the vehicle, said main PTO transmission unit comprising:
a first housing; and
a first gearing arranged in the first housing;
a main PTO output unit comprising:
a second housing; and
a second gearing arranged in the second housing, wherein the second housing is arranged to be attachable to the first housing of the main PTO transmission unit, wherein the second gearing is arranged to be engaged with the first gearing of the main PTO unit when the first housing is attached to the second housing, and wherein the first gearing is arranged to transfer torque to the second gearing of the PTO output unit;
an input shaft arranged to be connected to an output shaft of the power source of the vehicle; and
a first coupling arrangement, wherein the first coupling arrangement is arranged to couple and decouple the first gearing to the input shaft.

13. A vehicle comprising a powertrain for a vehicle, the powertrain comprising a main power take-off (PTO) comprising:
a main PTO transmission unit adapted to be mounted in series with, and in between, a power source and a transmission of the vehicle, said main PTO transmission unit comprising:
a first housing; and
a first gearing arranged in the first housing;
a main PTO output unit comprising:
a second housing; and
a second gearing arranged in the second housing, wherein the second housing is arranged to be attachable to the first housing of the main PTO transmission unit, wherein the second gearing is arranged to be engaged with the first gearing of the main PTO unit when the first housing is attached to the second housing, and wherein the first gearing is arranged to transfer torque to the second gearing of the PTO output unit;
an input shaft arranged to be connected to an output shaft of the power source of the vehicle; and a first coupling arrangement, wherein the first coupling arrangement is arranged to couple and decouple the first gearing to the input shaft.

14. (canceled)

15. (canceled)
